(19) United States
(12) Patent Application Publication
(10) Pub. No.: US 2013/0283635 A1
(43) Pub. Date: Oct. 31, 2013

(54) METHOD FOR DRYING ITEMS OF LAUNDRY

(71) Applicant: HERBERT KANNEGIESSER GMBH, Vlotho (DE)

(72) Inventor: Engelbert Heinz, Vlotho (DE)

(73) Assignee: Herbert Kannegiesser GmbH, Vlotho (DE)

(21) Appl. No.: 13/862,384

(22) Filed: Apr. 13, 2013

(30) Foreign Application Priority Data
Apr. 26, 2012 (DE) 10 2012 008 193.6

(51) Int. Cl. F26B 3/02

(52) U.S. Cl. CPC F26B 3/02
USPC 34/499

(57) ABSTRACT

Dryers are intended to operate in a manner in which energy is saved and laundry is treated gently. To this end, it is necessary to regulate the drying process in an optimum manner on the basis of the drying parameters and to find the time point for terminating the drying process which is most favourable for the laundry in question. The invention makes provision for at least one factor to be formed from a plurality of drying parameters and for the drying process to be terminated and/or for the drying process to be regulated on the basis of this factor. The factor can be formed by computer from a few drying parameters which are easy to detect, and regulation can be carried out in a simple manner with little expenditure on the basis of the factor by way of simple comparison with a setpoint value.

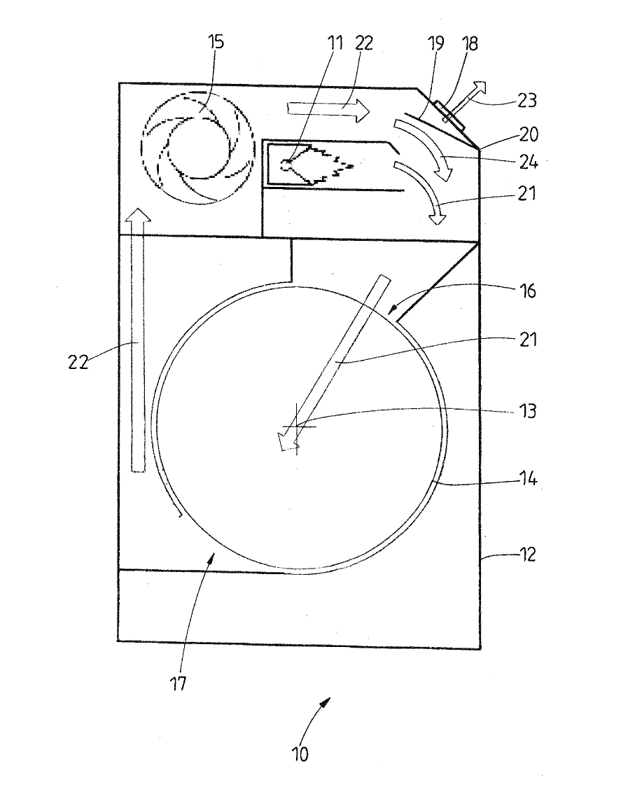

### STATEMENT OF RELATED APPLICATIONS

This application claims the benefit of German Patent Application No. 10 2012 008 193.6 having a filing date of 26 Apr. 2012.

### BACKGROUND OF THE INVENTION

1. Technical Field

The invention relates to a method for drying items of laundry, wherein the items of laundry are subjected to the action of hot air in a drying drum which is driven in rotation and are dried in the process, and the drying process is terminated when the items of laundry reach a prespecified degree of drying.

2. Prior Art

In commercial laundries, laundry of all kinds, in particular flat laundry, items of clothing, dirt-collection mats or the like, is dried in dryers having at least one drying drum which can be driven in rotation. Air which is heated by at least one burner is used for drying purposes, the said air being conducted as hot air through the drying drum containing the items of laundry which are to be dried. Drying is initially performed only with hot air which is heated by the burner. As the drying process progresses, drying is performed both with circulating air and with hot air, wherein the proportion of circulating air increases toward the end of the drying process. The ratio of hot fresh air and circulating air is set by at least one circulating-air flap.

The items of laundry must not be dried to such an extent that the moisture content is zero or virtually zero because, otherwise, there is a risk of the items of laundry being excessively dried, and this could result in the items of laundry being singed. The drying process is therefore terminated when the items of laundry still contain a certain degree of residual moisture which, however, must not be too high either because otherwise the items of laundry may be damaged, for example by the formation of mould, particularly when stored over a relatively long period of time.

To date, the drying process will have been terminated either by empirically determined values or on the basis of measuring various drying parameters. This procedure is either too inaccurate or requires a complex measuring technique. Furthermore, it is necessary to control or regulate the drying parameters such that energy consumption during drying is as low as possible. A great degree of importance is placed on this owing to increasing energy costs. Economically optimum drying requires complex control or regulation. This requires a high level of expenditure on measurement and control or regulation.

### BRIEF SUMMARY OF THE INVENTION

The invention is based on the object of optimizing, preferably simplifying, drying, in particular control or regulation of the drying process.

A method for achieving this object is a method for drying items of laundry, wherein the items of laundry are subjected to the action of hot air in a drying drum which is driven in rotation and are dried in the process, and the drying process is terminated when the items of laundry reach a prespecified degree of drying, characterized in that at least one factor is formed from a plurality of drying parameters and the drying process is controlled on the basis of this factor. Provision is accordingly made for at least one factor to be formed from a plurality of drying parameters and for the drying process to be terminated and/or for the drying process to be controlled or to be regulated on the basis of this factor. The factor in question can be formed in a simple manner, specifically primarily even from a relatively large number of drying parameters. The factor then constitutes a specific value according to which the drying process can therefore be terminated in a deliberate and exact manner and alternatively or preferably additionally simple yet equally precise control or regulation of the drying process is possible. Therefore, the drying process can be controlled or regulated in a simple, deliberate and reliable manner taking into consideration specific drying parameters using simple means and, in addition or as an alternative, it is possible to determine exactly when the drying process is concluded.

Provision is preferably made for the factor to be determined, specifically by computer, on the basis of a plurality of drying parameters several times in succession, preferably continuously, during drying. Factors are continuously determined or formed during the entire drying process in this way, as a result of which conclusions can be drawn about the course of drying, in particular the progress of drying, on the basis of factors which are determined in succession. Accordingly, the drying process can be exactly controlled or regulated in a simple manner. Primarily, the end of drying can be determined in a reliable manner on the basis of the factors.

According to a preferred embodiment of the method, the drying process is terminated when, in particular, a specific factor is reached. In this way, excessive drying, which could lead to the items of laundry which are to be dried being damaged, is effectively avoided and unnecessary energy costs are avoided.

Provision is preferably made for the factor to be compared with a prespecified switch-off value. The drying process is terminated as soon as the factor which is gradually determined during the drying process corresponds to the switch-off value. The drying process can therefore be terminated in a simple manner, wherein the factor which is continually, in particular continuously, determined during the drying process provides a reliable reference value. The end of drying can be determined in a very simple manner by continuous comparison of the respectively determined factor with the prespecified switch-off value.

In an advantageous refinement of the method, provision is made for defining the switch-off value individually as a function of the type of items of laundry which are to be dried. The switch-off value is determined, in particular, depending on the type of items of laundry which are to be dried. As an alternative or in addition, the switch-off value can also be defined as a function of the thickness of the laundry or the thickness of the fabric. In this way, a distinction can be drawn, for example, between terry towelling laundry and a thin laminate. The switch-off value is greater for relatively thick fabrics than for relatively thin fabrics. The switch-off value is also greater for fabrics which are not delicate.

The factor which is determined successively, in particular continuously, during the drying process can be used not only for determining the termination the drying process but, as an alternative or in addition, also for controlling or regulating the drying process. Since new factors are continuously determined during the drying process, the drying stage can be derived from this course and/or the current factor. The factor in question provides specific reference points for targeted control or regulation of the drying process.

Provision is preferably made for the drying process to be controlled or regulated by changing the angular position of a circulating-air flap of the dryer, the said change being dependent on the factor, and/or by adapting the falling curve of the items of laundry in the drying drum, preferably by correspondingly changing or adapting the rotation speed of the drying drum. Influencing the angular position of the circulating-air flap and the falling curve is essential for optimum drying. The position of the circulating-air flap and the falling curve is critical for the economic viability of drying. On the basis of the factors which are determined several times, preferably continually, during the drying process, the position of the circulating-air flap or the falling curve can be adjusted or adapted within very short time intervals, specifically ideally each time a new factor is determined, for accurate and high-resolution adaptation to the current drying stage and the associated drying state of the items of laundry.

According to a preferred development of the method, provision is made for time-related setpoint values of the factor to be defined in a manner distributed over the drying time and for the drying process to be controlled or regulated in such a way that the factors correspond to the setpoint values or approximate the said setpoint values as far as possible. Provision is particularly made for the respectively determined factor to be compared with the setpoint value in a time-related manner, that is to say a check is made to determine whether the factor which is determined after a specific drying period corresponds to the setpoint value which is associated with this drying period or not. In the case of deviations, at least one drying parameter is automatically changed, preferably the circulating-air flap position and/or the falling curve. The drying process and/or the degree of drying of the items of laundry are/is preferably continuously monitored, and accordingly controlled or regulated, in this way.

The invention makes provision for the respective factor to be determined from the drying parameters on the basis of a Mollier diagram (h-x diagram). It has surprisingly been shown that the factor can be determined from a few drying parameters in a manner which is particularly advantageous for the method according to the invention in this way.

Another advantageous refinement of the method makes provision for the drying parameter used for determining the at least one factor to be the feed-air temperature, the exhaust-air temperature, the surface temperature of the items of laundry which are to be dried and/or the angle of the position of a circulating-air flap of the dryer. The said drying parameters can be easily determined. In some cases, they have to be determined in any case. Therefore, no additional mechanical expenditure is required. It is only necessary for the obtained measurement values to be linked or converted according to the invention such that information can be derived about the progress of the drying process and the degree of drying of the items of laundry.

### BRIEF DESCRIPTION OF THE DRAWING

A preferred exemplary embodiment of the invention will be explained in greater detail below with reference to the drawing. The single FIGURE of the drawing shows a schematic cross section through a dryer with which the method according to the invention, amongst other things, can be carried out.

### DETAILED DESCRIPTION OF PREFERRED EMBODIMENTS

The dryer 10 illustrated in the figure serves for drying laundry in a highly effective and energy-efficient manner. A dryer 10 of this kind is used, primarily, in commercial laundries.

In the case of the shown dryer 10, air for drying the laundry is heated by a single burner 11. However, the dryer 10 can also have a plurality of burners 11 which are arranged in parallel or in series. The burner 11 may be any desired burner 11, preferably a gas burner or an oil burner.

The dryer 10 has an external housing 12, preferably a closed, box-like housing 12 in which a drying drum 14 which can be driven in rotation about a horizontal rotation axis 13, the said burner 11, a circulating-air fan 15 and corresponding aid-guidance ducts are arranged.

The drying drum 14 which can be driven in rotation serves to accommodate the items of laundry which are to be dried. The items of laundry are not shown in the figure. The drying drum 14 also has a loading and unloading opening—likewise not shown. In particular, the casing of the cylindrical drying drum 14 is designed to be permeable to air so that air which serves for drying purposes can flow through the drying drum 14 and the laundry which is to be dried and is located in the said drum. The drying drum 14 is partially surrounded by arcuate walls, which are impermeable to air, at a short distance from the cylindrical casing. The walls lie on a circular path which runs in a concentric manner about the rotation axis 13. The walls preferably leave free diametrically opposite openings, specifically an upper air-inlet opening 16 and a lower air-outlet opening 17.

The circulating-air fan 15 is located above the drying drum 14 in the housing 12, it being possible for the said circulating-air fan to be another air-flow generator, for example a blower. In addition to the circulating-air fan 15, the burner 11 is arranged approximately centrally in the upper region of the housing 12, specifically such that the axes of the flames run approximately horizontal transverse to the rotation axis 13.

An exhaust-air nozzle 18 is located in a bevelled, upper, right-hand-side region of the housing 12. The exhaust-air nozzle 18 has an associated temperature sensor—not shown—with which the exhaust-air temperature can be determined.

A circulating-air flap 19 is provided in the interior of the housing 12 beneath the exhaust-air nozzle 18. The circulating-air flap 19 can be pivoted about a preferably horizontal pivot axis 20 by a drive—not shown. The circulating-air flap 19 can be pivoted to such an extent that firstly it completely closes the exhaust-air nozzle 18 in an open position and secondly completely opens the exhaust-air nozzle 18 in a closed position and completely interrupts or suppresses a flow of circulating air to the air-inlet opening 16 in the drying drum 14. Any desired intermediate positions of the circulating-air flap 19 are possible between the said extreme positions. The angular position of the circulating-air flap 19 can be determined by an angle sensor—not shown.

In the case of the described dryer 10, the drying process proceeds as follows:

At the beginning of the drying process, air 21 which is heated by the burner 11 is conducted via the air-inlet opening 16 to the drying drum 14 which is driven in rotation and contains the laundry which is to be dried and is located in the said drying drum. As it flows along the damp laundry, the heated air 21 absorbs moisture. As a result, moist air 22 is discharged out of the drying drum 14 through the air-outlet opening 17. The moist air 22 is transported away by the circulating-air fan 15. When the circulating-air flap 19 is completely closed, all the moist air 22 is routed to the outside through the exhaust-air nozzle 18. The discharged moist air 22 is replaced by fresh air which is heated by the burner 11 and arrives at the drying drum 14 through the air-inlet opening 16 as heated air 21 without circulating air.

As the drying process progresses, the amount of moisture in the moist air 22 decreases. A portion of the moist air 22 is then supplied, past the burner 11, to the drying drum 14 containing the laundry which is to be dried and is contained in the said drying drum again as circulating air. For this purpose, the circulating-air flap 19 is partially opened by pivoting in the clockwise direction (in relation to the figure) about the pivot axis 20. The circulating-air flap 19 is opened to such an extent that the desired circulating-air stream is set, that is to say a targeted proportion of the moist air 22 is supplied to the drying drum 14 again as circulating air 24 and a remaining portion of the moist air 22 is conducted through the exhaust-air nozzle 18 to the outside as exhaust air 23. The proportion of exhaust air 23 which is conducted to the outside is replaced by fresh air which is heated by the burner 11 and is supplied through the air-inlet opening 16 to the drying drum 14 as heated air 21 together with the circulating air. In this case, only that portion of the moist air 22 which is conducted to the outside as exhaust air 23 is replaced. As the drying period increases, the proportion of circulating air 24 is successively increased. To this end, the circulating-air flap 19 is gradually opened further, with the result that it closes the exhaust-air nozzle 18 more and more, and less moist air 22, which still contains a considerable amount of residual heat, escapes to the outside through the exhaust-air nozzle 18.

The method according to the invention will be explained in greater detail below with reference to the dryer 10 which is described above:

According to the invention, current factors are formed from a plurality of drying parameters during the drying process. The factors are used firstly to control or to regulate the drying process and secondly to terminate the drying process. However, the invention is not restricted to this. The method according to the invention can also relate to terminating the drying process on the basis of the factor or controlling or regulating the drying process on the basis of the continually determined factors.

In the present exemplary embodiment, the angular position of the circulating-air flap 19 which is determined by an angle sensor, the feed-air temperature which is determined by a temperature sensor, that is to say the temperature of the fresh air which is to be heated by the burner 11, the exhaust-air temperature which is likewise determined by a temperature sensor, that is to say the temperature of the moist air 22 which leaves the exhaust-air nozzle 18, and the surface temperature of the dried laundry are used as drying parameters to form the factors. The surface temperature of the dried laundry is determined by a sensor which is associated with the drying drum 14, for example an infrared sensor, in a contact-free manner.

The said drying parameters are continually determined during the entire drying process specifically continuously or at regular time intervals, that is to say with intervals between successive determination operations for the factors, it being possible for the said intervals to be determined in respect of duration. This produces current factors based on the current drying phases. The factors can have respective associated drying periods, with the result that time-related factors or factors which are standardized in respect of time are formed. The factors are determined by computer using, for example, a microcomputer on the basis of the Mollier diagram (h-x diagram).

In order to determine the end of the drying process, a switch-off value is defined in relation to the laundry which is to be dried in each case, specifically depending on the type of laundry, in particular the type of fabric and/or the thickness of the laundry. When the determined factor reaches this value, the drying process is automatically terminated. The switch-off value is defined such that it lies between 0 and 100, where 0 is wet laundry and 100 is severely excessively dried laundry which no longer contains hardly any residual moisture, while a switch-off value below 100 corresponds to the optimum drying point. This switch-off value is defined in accordance with the type of laundry. The switch-off value is the setpoint value of the factor. When the factor reaches the switch-off value, this means that the optimum drying point of the laundry has been reached. The drying process is then terminated.

In order to be able to establish when the switch-off value which represents the optimum drying point for the respective laundry is reached, the factor is preferably determined continuously during the entire drying process. If the intention is only for the drying process to be automatically terminated on the basis of the factor, it may be sufficient to begin forming the factor only after a certain initial drying time has elapsed. Determination of the factor is started when, according to experience, the majority of the drying process is concluded but it is certain that the switch-off value which is defined for the laundry in question has not yet been reached.

In order to control or regulate the drying process, drying-time-related factors are preferably determined over the entire drying process in succession, specifically either at regular time intervals or continuously one after the other. This produces a series of factors for the drying period in question. The factors are preferably recorded, in particular stored, based on the associated drying period, that is to say at the time point starting from the beginning of the drying operation at which they were determined.

The determined time-related factors are compared with setpoint values which are associated with the drying period in question. The factor which is determined at this drying period is compared with the setpoint value of a specific drying period. The drying process is correspondingly controlled or regulated in the event of a deviation.

For the purpose of controlling or regulating the drying process, deviations in each factor which is based on a specific drying period can be established for the setpoint value which relates to the same drying period and accordingly the drying process can be controlled or regulated by reference to corresponding drying parameters.

It is also feasible to form a trend or prognosis from a plurality of successive factors. The drying parameters are correspondingly influenced. It is also feasible for specific drying parameters to be influenced on the basis of the current comparison of the factor with the setpoint value while other drying parameters on the basis of the profile or the trend of a plurality of factors and their comparison with the temporally matching setpoint values remain unchanged.

The position of the circulating-air flap 19 is preferably controlled, that is to say a corresponding value for the angular position of the circulating-air flap 19 is set and/or the falling curve of the laundry in the drying drum 14 is changed, on the basis of the factors, in particular their comparison with the associated setpoint values. This is done in such a way that a falling curve which changes as the laundry becomes increasingly dry is adapted by a corresponding change in the rotation speed of the drying drum 14. In this way, the falling curve of the laundry can be matched to the current degree of drying of the laundry in the drying drum 14 so that the falling curve which is optimum for the laundry which is to be dried is always produced in the drying drum 14 which is driven in rotation.

By controlling or regulating the circulating-air flap position on the basis of the measured angular position of the said circulating-air flap, the proportion of circulating air can be increased in an optimum manner, specifically preferably continuously, as the laundry is increasingly progressively dried as a function of the factor which is continuously determined over the drying process and preferably by comparison of the respectively determined factor with the associated setpoint value. In this way, as much still-hot circulating air as possible can be re-used for drying the laundry as a result of being returned to the drying drum 14. This leads to particularly energy-efficient drying.

It is also feasible to change, in particular to control or to regulate, other drying parameters using the factors which are determined during drying. These can be, for example, the rotation speeds of the drying drum 14 and/or the circulating-air fan 15, but also the temperature to which the burner 11 heats the air 21.

The method according to the invention is suitable not only for the dryer 10 which is described in the introductory part, but also for dryers of different construction, specifically those for commercial laundries in particular.

### LIST OF REFERENCE SYMBOLS:

10 Dryer

11 Burner

12 Housing

13 Rotation axis

14 Drying drum

15 Circulating-air fan

16 Air-inlet opening

17 Air-outlet opening

18 Exhaust-air nozzle

19 Circulating-air flap

20 Pivot axis

21 Heated air

22 Moist air

23 Exhaust air

24 Circulating air

What is claimed is:

1. A method for drying items of laundry, comprising:
subjecting the items of laundry to the action of hot air (21) in a drying drum (14) which is driven in rotation and drying the items of laundry in the process;
terminating the drying process when the items of laundry reach a prespecified degree of drying; and
controlling the drying process on the basis of a factor formed from a plurality of drying parameters.

2. The method according to claim 1, wherein the drying process is terminated when the factor is reached.

3. The method according to claim 1, wherein a plurality of factors is determined by computer on the basis of the plurality of drying parameters in succession during drying.

4. The method according to claim 3, wherein the drying process is terminated when the factors are reached.

5. The method according to claim 1, further comprising comparing the factor with a prespecified switch-off value, wherein the drying process is terminated as soon as the factor that is determined during the drying process corresponds to the switch-off value.

6. The method according to claim 5, wherein the switch-off value is defined individually as a function of the type of items of laundry which are to be dried.

7. The method according to claim 5, wherein the switch-off value is greater for items of laundry which are composed of relatively thick materials than for items of laundry which are composed of relatively thin materials.

8. The method according to claim 1, wherein the drying process is controlled on the basis of a plurality of factors that are determined one after the other during the drying process.

9. The method according to claim 8, wherein the drying process is controlled by a change in the angular position of a circulating-air flap (19) of the dryer (10), the said change being dependent on the plurality of factors.

10. The method according to claim 8, wherein the drying process is controlled by a change in a falling curve for the items of laundry in the drying drum (14), the said change being dependent on the plurality of factors.

11. The method according to claim 1, wherein a plurality of factors is determined continuously in succession on the basis of the drying parameters during drying.

12. The method according to claim 8, further comprising defining time-related setpoint values of the plurality of factors in a manner distributed over the drying time and the drying process is controlled in such a way that the plurality of factors correspond to the setpoint values or approximate the said setpoint values as far as possible.

13. The method according to claim 12, wherein the factor that is determined at the respective time point in the drying process approximates the setpoint value that is associated with this time point at least as far as possible.

14. The method according to claim 1, wherein the factor is determined from the drying parameters using a Mollier diagram.

15. The method according to claim 1, wherein the drying parameter used for determining the factor is the feed-air temperature.

16. The method according to claim 1, wherein the drying parameter used for determining the factor is the exhaust-air temperature.

17. The method according to claim 1, wherein the drying parameter used for determining the factor is the surface temperature of the items of laundry which are to be dried.

18. The method according to claim 1, wherein the drying parameter used for determining the factor is the angle of the position of a circulating-air flap (19) of the dryer (10).
